(19) United States
(12) Patent Application Publication
(10) Pub. No.: US 2014/0379590 A1
(43) Pub. Date: Dec. 25, 2014

(54) Intellectual Asset Portfolio Evaluation Methods And Systems

(71) Applicant: Paul B. Germeraad, Saratoga, CA (US)

(72) Inventor: Paul B. Germeraad, Saratoga, CA (US)

(73) Assignee: Questel SAS, Paris (FR)

(21) Appl. No.: 14/274,733

(22) Filed: May 11, 2014

Related U.S. Application Data
(60) Provisional application No. 61/837,127, filed on Jun. 19, 2013.

(51) Int. Cl. G06Q 50/18; G06Q 10/00

(52) U.S. Cl. CPC G06Q 50/184; G06Q 10/00
USPC 705/310

(57) ABSTRACT

A computer implemented method for evaluating intellectual property assets includes identifying a source portfolio of intellectual property assets, identifying a comparable portfolio of intellectual property assets, determining an outstanding business use statistical control limit (OBUSCL) for a plurality of parameters associated with the intellectual property assets and determining a strength of the source portfolio based on the OBUSCL.

### RELATED AND PRIORITY APPLICATION

The present application claims priority to U.S. Provisional Patent Application No. 61/837,127 filed on 19 Jun. 2013, the subject matter of which is incorporated in its entirety by reference.

### BACKGROUND

Exemplary embodiments are related to intellectual property assets and more particularly to methods, processes and systems for evaluation of the intellectual property assets in assisting with a licensing or monetization of these assets. An automated method for evaluating intellectual property portfolio evaluation is desirable.

### SUMMARY

In accordance with an exemplary embodiment, a computer implemented method for evaluating intellectual property assets is disclosed. The method comprises the steps of: identifying a source portfolio of intellectual property assets, identifying a comparable portfolio of intellectual property assets, computing metrics for a plurality of parameters associated with the intellectual property assets, comparing the computed metrics of the source portfolio with computed metrics of the comparable portfolio parameters of all portfolios and determining a strength of the source portfolio based on the comparison, wherein the compared parameters are divided into a plurality of categories, the categories including at least validity and ownership value of the assets, technical and use value of the assets and geographic value of the assets.

In accordance with another exemplary embodiment, a computer implemented method for evaluating intellectual assets is disclosed. The method comprises the steps of: identifying a source portfolio of intellectual property assets, identifying a comparable portfolio of intellectual property assets, determining an outstanding business use statistical control limit (OBUSCL) for a plurality of parameters associated with the intellectual property assets and determining a strength of the source portfolio based on the OBUSCL.

In accordance with a further exemplary embodiment, a computing device is disclosed. The computing device comprises: a user interface for receiving user input and for displaying data to the user, a transceiver for enabling the computing device to communicate with a server located remote from the computing device, a memory for storing user input and data obtained from the server and a processor configured to: identify a source portfolio of intellectual property assets based on the user input, identify a comparable portfolio of intellectual property assets, determine an outstanding business use statistical control limit (OBUSCL) for a plurality of parameters associated with the intellectual property assets and determine a strength of the source portfolio based on the OBUSCL.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a licensing process for an intellectual property asset;

FIG. 2 illustrates an evaluation method for an intellectual property asset in accordance with exemplary embodiments;

FIG. 3 illustrates an exemplary project execution process;

FIG. 4 illustrates a method for identifying intellectual property assets for licensing purposes in accordance with exemplary embodiments;

FIG. 5 illustrates a method for determining the strength of intellectual property assets in accordance with exemplary embodiments;

FIG. 6 illustrates a radar (or spider) diagram highlighting measures of source and comparable intellectual property assets in accordance with exemplary embodiments;

FIG. 7 illustrates a radar diagram highlighting measures of source and comparable intellectual property assets with respect to validity in accordance with exemplary embodiments;

FIG. 8 illustrates a radar diagram highlighting measures of source and comparable intellectual property assets with respect to strength and technical use in accordance with exemplary embodiments;

FIG. 9 illustrates a radar diagram highlighting measures of source and comparable intellectual property assets with respect to geographic coverage in accordance with exemplary embodiments;

FIG. 10 illustrates a bar graph highlighting measures of source and comparable intellectual property assets in accordance with exemplary embodiments;

FIG. 11 illustrates a bar graph highlighting measures of source and comparable intellectual property assets with respect to validity in accordance with exemplary embodiments;

FIG. 12 illustrates a bar graph highlighting measures of source and comparable intellectual property assets in accordance with exemplary embodiments;

FIG. 13 illustrates a bar graph highlighting measures of source and comparable intellectual property assets with respect to validity in accordance with exemplary embodiments;

FIG. 14 illustrates a computing device for implementing methods in accordance with exemplary embodiments; and

FIG. 15 illustrates a method in accordance with an exemplary embodiment.

### DETAILED DESCRIPTION

The various features of exemplary embodiments will now be described with reference to the figures, in which like parts are identified with the same reference characters. To facilitate an understanding, many aspects are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors).

Moreover, exemplary embodiments can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects may be embodied in many different forms, and all such forms are contemplated to be within the scope of the exemplary embodiments. For each of the various aspects, any such form of embodiments as described above may be referred to herein as “logic configured to” perform a described action, or alternatively as “logic that” performs a described action.

In exemplary embodiments, methods, processes, apparatus and systems are disclosed for evaluating intellectual property assets. Such evaluation may be used in the licensing and monetization of these assets.

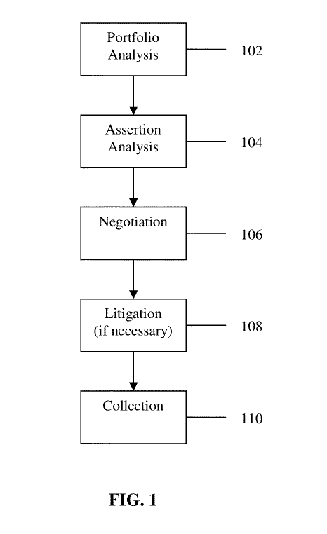

A licensing process for an intellectual property asset (such as a patent) may include a plurality of stages. As illustrated in FIG. 1, a licensing 100 process may include, but is not limited to, a portfolio analysis stage 102, an assertion analysis stage 104, a negotiation stage 106, a litigation stage 108 and a collection stage 110.

Once a business goes through the research and development (R&D) stages for multiple products and/or services, a R&D portfolio may be created. Projects and/or services in the R&D portfolio may eventually be protected by one or more patents to create a patent portfolio. In order to receive a reward and benefit for its efforts, it is desirable for a business with such a portfolio to be able to leverage its patents (e.g. monetization of assets). The portfolio analysis stage 102 investigates the patents of a company and determines how to license one or more of the patents contained therein.

In the assertion analysis stage 104, each patent in the portfolio may be analyzed and a determination is made as to how it (i.e. the patent) will be asserted. Typical ways of taking action on a patent includes litigation, out-licensing, donating, maintaining or abandoning the patent. Typical questions asked at this stage can include: (1) Do multiple patents protect similar technology or commercial use?; (2) Are competitors interested in the technology protected by one or more patents?; and (3) Do any patents cover technology that is out-dated? More particularly, the patents in the portfolio are screened against public statements, products and/or services offered by others to determine if any claimed features or elements might be used by another entity or company. Web crawlers, corporate intelligence and reverse engineering are some examples of how this information may be gathered. This information can then be analyzed and potential infringement can be highlighted for a follow-up.

In the negotiation stage 106, one or more people or entities may be identified as being interested in licensing one or more of the patents in a patent portfolio. During this stage, the market of the patent for which a license is being negotiated may be evaluated.

The litigation stage 108 may or may not be necessary, but typically occurs when patent rights are asserted against a third party and the third party challenges the patent's validity.

The collection stage 110 includes the process of collecting royalty fees for a license. The collection team usually has an understanding of how well a licensed patent should be doing in the market in order to determine the amount of royalties the user (e.g. licensor) company can expect to receive.

The amount of resources (e.g. time and energy) allocated to each stage in the licensing process for each patent in a portfolio depends, partly, on the particular patent. For example, a patent may have great economic value or it may have little economic value.

While it may be desirable to facilitate, expedite and enhance the licensing process by building upon work that has been previously performed, there are no automated tools for assisting in this process.

Exemplary automated intellectual asset evaluation methods and apparatus as described herein may be utilized to assist in different stages of a licensing process such as the licensing process 100 described above with reference to FIG. 1.

An exemplary evaluation method may include, but is not limited to, a plurality of processing steps as described in further detail herein below.

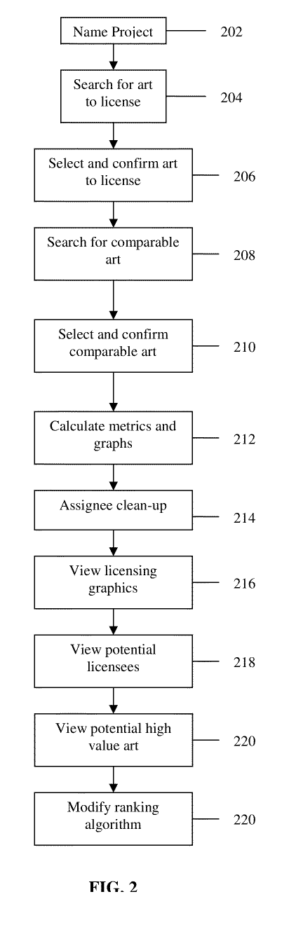

Referring to FIG. 2, the processing steps of an exemplary evaluation method 200 may include naming a project at 202, searching for or identifying intellectual asset(s) (such as a patent) to be licensed at 204, selecting and confirming intellectual asset(s) (from the assets that were searched) to be licensed at 206, searching for or identifying comparable intellectual assets at 208, selecting and confirming comparable intellectual asset(s) (from those searched) at 210, calculating a plurality of metrics and presenting them in a graphical form at 212, cleaning up assignments at 214, viewing licensing graphics at 216, viewing potential licensees at 218, viewing potential high value assets at 220 and modifying a ranking algorithm at 222.

Utilizing the information from the processing steps illustrated in FIG. 2 speeds up and develops a higher-quality output for evaluation than is currently available. Exemplary methods, systems and processes are described in further detail below.

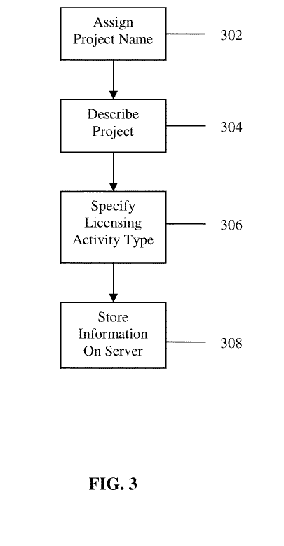

Referring to FIG. 3, a project process 300 may includes a plurality of steps. A project name may be selected at 302 and a description for the project may be provided at 304. The project description may include products included in the project and purposes of the project. The type of licensing activity may be specified at 306. The type of licensing activity may be identified as either being an assertive licensing activity or as a proactive licensing activity. The information from steps 302, 304 and 306 may be stored at 308.

In assertive licensing, the licensing (or, source) assets or portfolio usually includes granted patents that are alive (i.e. in force or not expired). The comparable assets or portfolio also includes granted patents that are in force. The assumption is that the (potential) licensee will fight back against the licensing activity of the licensor and/or actively work to invalidate or reduce the worth of the licensor's patents if possible.

In proactive licensing, a licensing portfolio includes both pending applications and granted patents that are in force. The comparable portfolio also includes pending applications and granted patents that are in force. The assumption in this scenario is that the (potential) licensee will not fight back against the licensing activity of the licensor and proactively work with the licensor to increase the worth of the license if possible. Each of the inputs may be stored in a server.

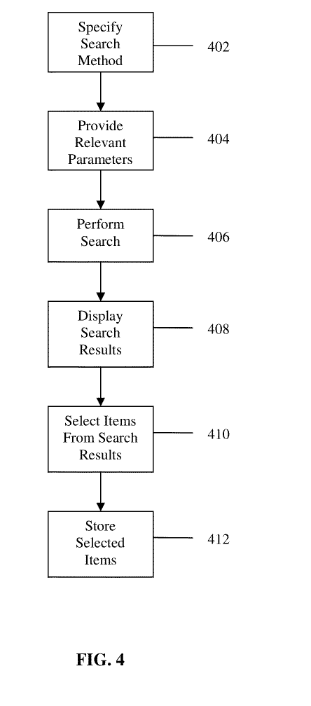

The searching for and identifying of intellectual assets (e.g. patents) to be licensed out (i.e. source portfolio) may be described with reference to FIG. 4. A searching method may be specified at 402. A method of searching may be by inventor name(s) and/or assignee names for example. Another method may be by patent numbers. A pre-specified list (of criteria for example) stored on a server may also be used to perform the search.

In order to perform the search, relevant parameters for the type of search specified such as keywords, classification codes, names, numbers legal status characteristics or location of a pre-specified list may be provided at 404. A search may be performed based on the specified criteria at 406. Results of the search may be displayed at 408.

The results from the search may be provided as a list. Each item in the result list may include a means for facilitating selection of items in the list. The selection means may include a checkbox, a radio button or the like. The selection means may be actuated by a user at 410 in some embodiments. The selected items (representing the source portfolio) may be stored in a server at 412.

The user selection provides the user with an opportunity to verify intellectual assets that are being selected for licensing. In some instances, for a variety of reasons, there may exist a strategic or a business reason to not select certain assets (resulting from the specified search) for licensing. It is also desirable to allow a user to deselect any documents seen as irrelevant from a human subject matter expert perspective.

After identifying and selecting a source portfolio, a search, selection and confirmation of comparable assets or portfolio may be performed. The assets in the comparable portfolio may represent work of others in the same or closely related field as the source portfolio.

The methods described above for searching for a source portfolio may also be utilized in searching for a comparable portfolio. However, in searching for comparable portfolio of assets, an additional method may be utilized.

The additional method may be an algorithm for searching for and identifying comparable patents. A similarity algorithm may be used to search for comparable assets. The similarity algorithm uses the Cooperative Patent Classification (CPC) code(s) assigned to a patent publication to find all publications classified under the same code(s). International Patent Classification (IPC) codes may also be used.

Identified assets resulting from utilizing the similarity algorithm may be ranked by relevance and displayed. Therefore, the first results are publications or assets which have the most points of similarity. Hence, the algorithm may include citations of the source portfolio (both forward and backward), classification codes in the source portfolio and similar keywords or concepts (derived by the analyzing algorithm that can be implemented as software) found in the source portfolio.

Upon completing a search (for comparable portfolio) based on the specified method, a list of patents may be provided for selection (by a user for example). As with the source portfolio described above, the selection may be made via a checkbox, a radio button or the like. The user selection of assets from the comparable portfolio may be stored on a server.

In some embodiments, each patent in the comparable list may also include a relevance score that indicates how close or similar a patent in the comparable list is to one or more patents in the source list. Patents in the comparable list may be selected based on the relevance score or those that exceed a pre-specified relevancy score.

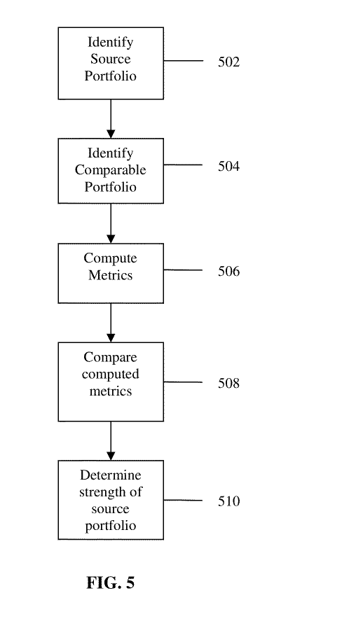

A method in accordance with exemplary embodiments may be described with reference to FIG. 5. A source portfolio is identified at 502 as described above. A comparable portfolio is identified at 504. Metrics may be computed on the respective portfolios at 506. The computed metrics may be analyzed at 508. The computed metrics may be utilized to determine the strength of the source portfolio at 510.

A number of exemplary parameters (though not exhaustive) corresponding to patents or patent applications are described. Forward cited patents and backward cited patents for a patent may be obtained and analyzed. The terms forward and backward are used relative to a reference patent. A forward cited patent refers to a patent that cites the reference patent. A backward cited patent refers to a patent that is cited by the reference patent. The forward patent thus may be dated subsequent to the reference patent. The backward patent may be dated earlier than the reference patent.

The assignee for each patent in the source patent portfolio list may be obtained for example. The assignee information for each patent application may also be obtained. Similar information may also be obtained for the comparable patent portfolio list (i.e. assignee information for patents and patent applications).

A list of assignees for the source patent portfolio and the number of patents and/or applications for each assignee may be provided. A similar list may be provided for the comparable patent portfolio.

For the source patent portfolio, assignees that are known to belong to each other (such as related entities or entities pooling their assets for example) may be grouped together. Some assignees may not be appropriate for licensing activity and such assignees may be excluded. Banks and holding companies may be examples of entities that are not typically appropriate for licensing activity. A similar grouping and/or exclusion may also be applied to the comparable patent portfolio. Assignees that are of interest may be selected.

For the source patent portfolio, specific metrics or measures that can be utilized in the evaluation for licensing activities may be computed. The measures associated with licensing patent portfolios can be divided into a plurality of categories. These categories may include, but are not limited to, validity and patent prosecution measure, technology and use measure and geographic measure.

The validity and patent prosecution measures associated with licensing patent portfolios are highlighted and their significance is described in Table I. This exemplary listing includes measures associated with the validity and ownership value of patent assets and their relevance in determining the strength of the assets.

The strength and value measures associated with licensing patent portfolios are highlighted and their significance is described in Table II. This exemplary listing includes measures associated with the strength of the underlying technology of a patent as well as the commercial utility of such a use or technology.

The geographic measures associated with the strength of a patent portfolio are highlighted and their significance is described in Table I. The geographic strength of a patent portfolio can be estimated from the countries in which a patent has been filed or obtained.

In order to assess the source portfolio against all the art (patents) found in the comparable portfolio, a graphic display of the measures (such as those included in each of the three categories identified above and listed in Tables I, II and III) facilitates an effective decision making from a business point of view. Radar diagrams and bar diagrams can be used to display such comparative information.

The patent documents from each assignee can be checked to ensure all documents for a specific assignee are correctly identified with that assignee. This may utilize (optionally) software lookup tables, fuzzy logic algorithms, artificial intelligence algorithms, subject matter expert identification or other means that groups patents from the same assignee together into an identified assignee list.

From the assignee lists so obtained, values for each individual measure for each individual assignee may be averaged to obtain an average individual measure value for each assignee present in the source and comparable groups.

The assignee average measure values may then be listed and the minimum, maximum, average and standard deviation of the assignee average value list may be computed. These values may be plotted on one axis of a radar, bar, or other graph forms.

Points on any individual radar axis or stacked bar may include the minimum, maximum, average, or standard deviation markers, along with a marker for the value of the source or other assignee portfolios. When the number of source portfolio documents is small enough to prevent visual clutter of the resulting radar or other graphic display, individual values of the patent documents may be displayed in lieu of, or in addition to, the individual values for an assignee's documents.

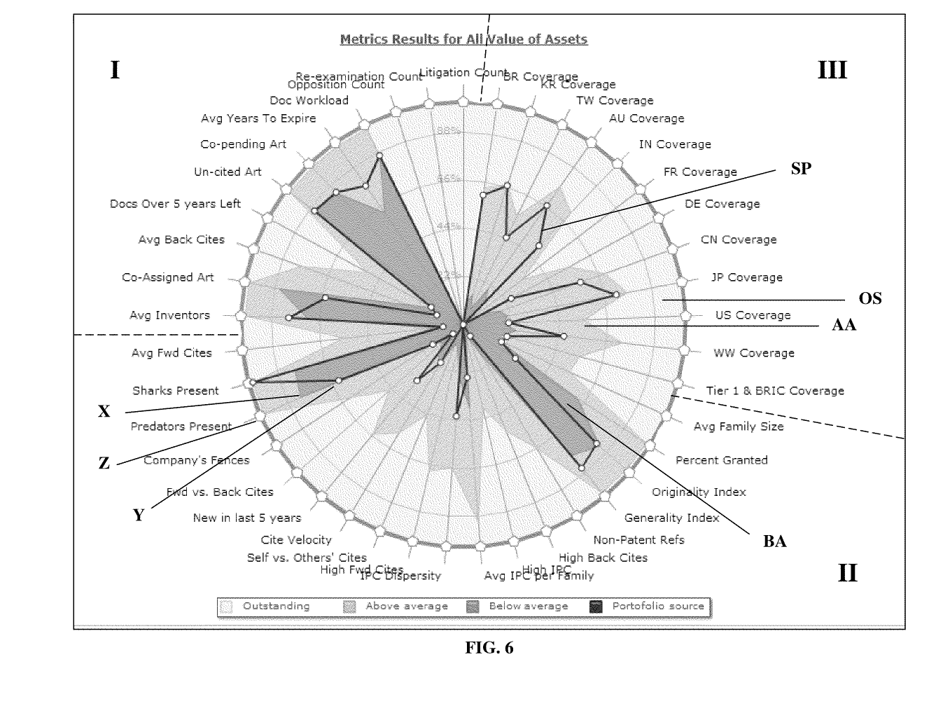

An exemplary radar (or spider) diagram is illustrated in FIG. 6. The goal of such a diagram is to determine if the source portfolio is likely to generate business returns from out licensing. In FIG. 6, the various measures included in the three categories identified above are illustrated and designated as I, II and III respectively. Each of these areas is separated from the other areas by dashed lines in FIG. 6.

These measures may be divided into the three areas corresponding to the measures described above with respect to validity, technical/use strengths and geographic measures. The (first) area, designated as I, relates to the validity measures which evaluate prosecution, maintenance and litigation aspects. The next (or second) area, designated as II, relates to the strength and value measures which evaluate citations. The third area, designated as III, relates to the geographic measures.

For each of the measures, a value may be obtained for all patent documents from each assignee in the source portfolio and comparable portfolio(s). An average value for each of these measures may be computed for each, as well as for all, of the assignees.

In FIG. 6, the average value of a measure for all assignees is illustrated at the point where the dark shaded background meets the medium shaded background along an axis representing the particular measure and is designated by X. The average value of the same measure for the source portfolio is illustrated at the point (white circle) designated by Y. The average values of the same measure for other assignees may also be plotted along this axis—this is not illustrated in FIG. 6 in order to reduce the amount of information (and avoid cluttering) on the radar diagram.

An assignee having the highest average for the same measure is illustrated along the circumference of the radar diagram and is designated by Z in FIG. 6. An assignee having the lowest average for the same measure is at the origin of the radar diagram (i.e. at the center of the circle) and is not specifically illustrated in FIG. 6.

The dark shaded area BA of FIG. 6 illustrates values below the average value for a particular measure. The medium shaded area AA of FIG. 6 illustrates values above the average for a particular measure. The light shaded are OS of FIG. 6 illustrates outstanding values (much above average for example) for a particular measure. The average values for each measure of the source portfolio (i.e. the Y for each measure) are connected and designated by SP.

Additional statistical parameters such as standard deviation can be computed and included in the radar graph of FIG. 6. The significance of these parameters will be address further below.

In the case of one representative individual measure, Sharks Present In Citation Patent Fences (from Table II), in an exemplary situation, the source portfolio has five patents from one assignee entity, and the comparable portfolio has 150 patents from a variety of 25 assignees. The assignee with the largest number of patent documents in the comparable portfolio has 50 patent documents, the next largest assignee has 25 documents, the third largest assignee has 15 documents, the fourth largest assignee has 11 documents, the fifth largest assignee has 8 documents, the next 10 largest assignees have 4 documents each, and the remaining assignees have 1 document each.

In this exemplary case, suppose only one of the five patents in the source portfolio has a Shark in the forward citations of its patents. A “Shark” may be defined as an entity that has over 30% of the forward citations from an individual patent document, or alternatively a patent family. If the only patents in the comparable portfolio that have sharks as defined above are seven, three from the assignee with 11 documents, two from an assignee with 4 documents, and one patent followed by a shark from three other of the assignees with 4 documents.

Then, for the combined assignee entities in the source and comparable portfolios, the average number of documents that have Sharks Present In Citation Patent Fences for any assignee is approximately 0.07, the standard deviation is approximately 0.13, the average plus two times the standard deviation (the control limit or Outstanding Business Use Statistical Control Limit, OBUSCL) is 0.33, the maximum is 0.50, and the minimum for any entity is zero.

The source portfolio in this example has as its average number of documents that have Sharks Present In Citation Patent Fences as 0.20. This exemplary representative individual measure may be plotted by normalizing the values for each assignee to between zero (to correspond to the minimum value of 0.00) and 1.00 (to correspond to the maximum value of 0.50).

For the source portfolio, the normalized value to be plotted on the exemplary representative individual measure axis is approximately 0.4. The comparable assignee with 11 documents (three of the eleven with sharks in the forward citations) the value would be approximately 0.54. The comparable assignee with 4 documents (two of the four with sharks in the forward citations) the value would be 1.00 (maximum). The three comparable assignees with 4 documents (one of the four with sharks in the forward citations) the values would be approximately 0.50. The average would be plotted as approximately 0.13 and the control limit or OBUSCL as approximately 0.68. One skilled in the art would calculate other individual measures in a similar manner.

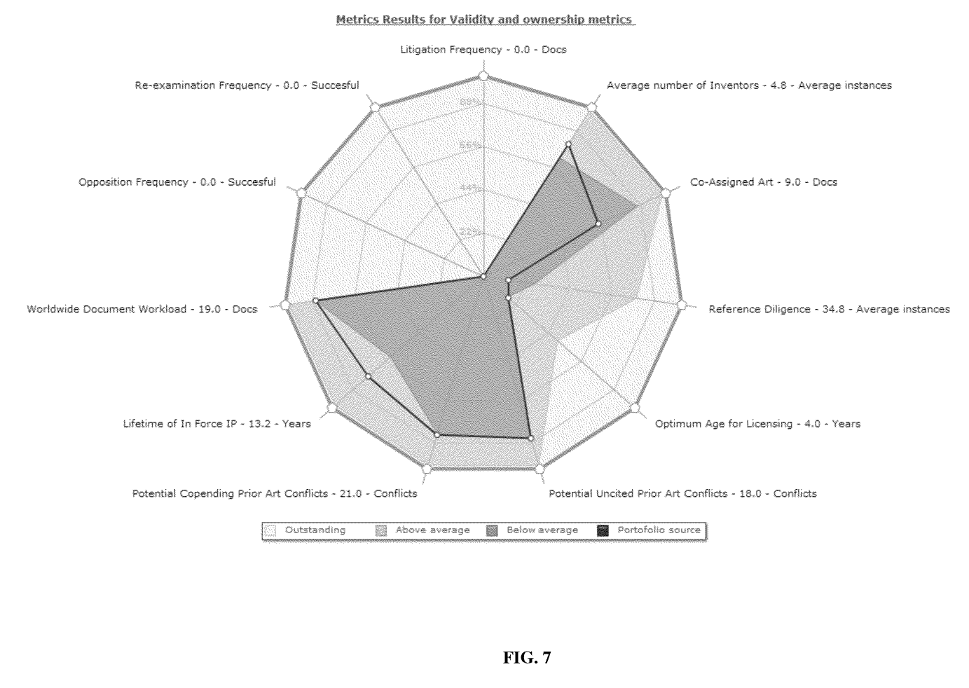

Exemplary individual graphs for each of the three areas (validity, technical/use strengths, geographic) are illustrated in each of FIGS. 7, 8 and 9 respectively. Such a display can be used to illustrate the strengths, weaknesses, opportunities and threats to a (user) company's portfolio. In FIGS. 6-9, a high-level assessment of the source portfolio strengths and weaknesses versus the same measures of a comparison portfolio is computed and illustrated.

The metrics results of the source portfolio (for prosecution and litigation related attributes) are illustrated in FIG. 7. For a particular licensing portfolio, this graph highlights the likelihood of encountering a problem (in a potential future litigation for example).

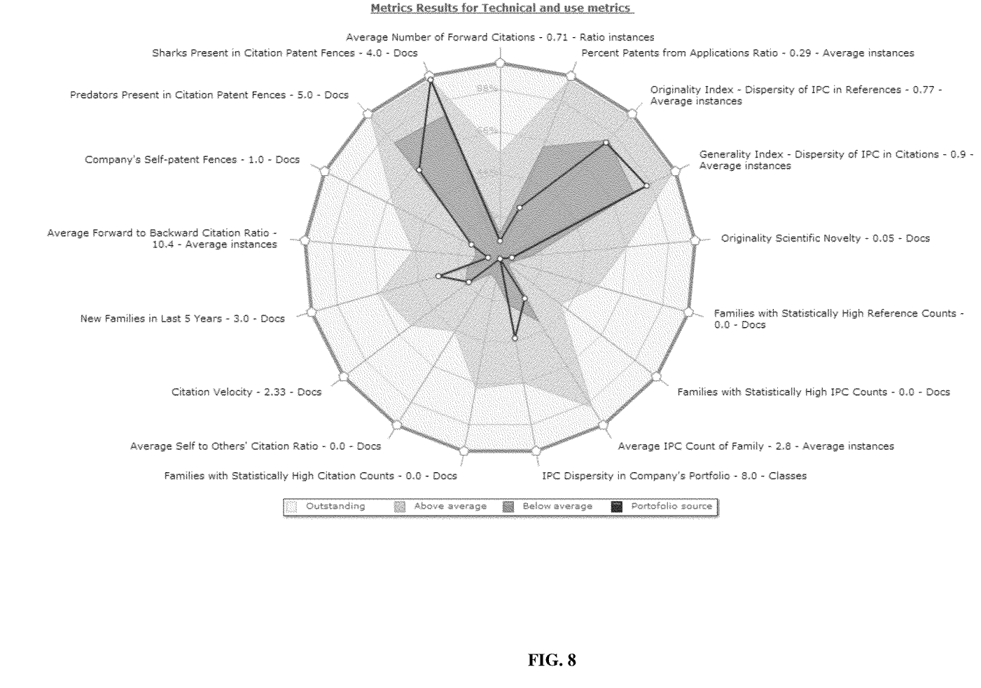

Referring to FIG. 8, the source portfolio is compared to the comparable portfolio on attributes normally associated with how original the art might be. From a business development or R&D standpoint, a determination is made as to whether a patent within the source portfolio is incremental, next generation or breakthrough when compared to other art in the field. Another aspect to be evaluated is whether the technology in a patent covers areas outside those originally contemplated by the original filing entity. That is, does the art cover unintended new uses or is it very narrow and only useful in a specific industry.

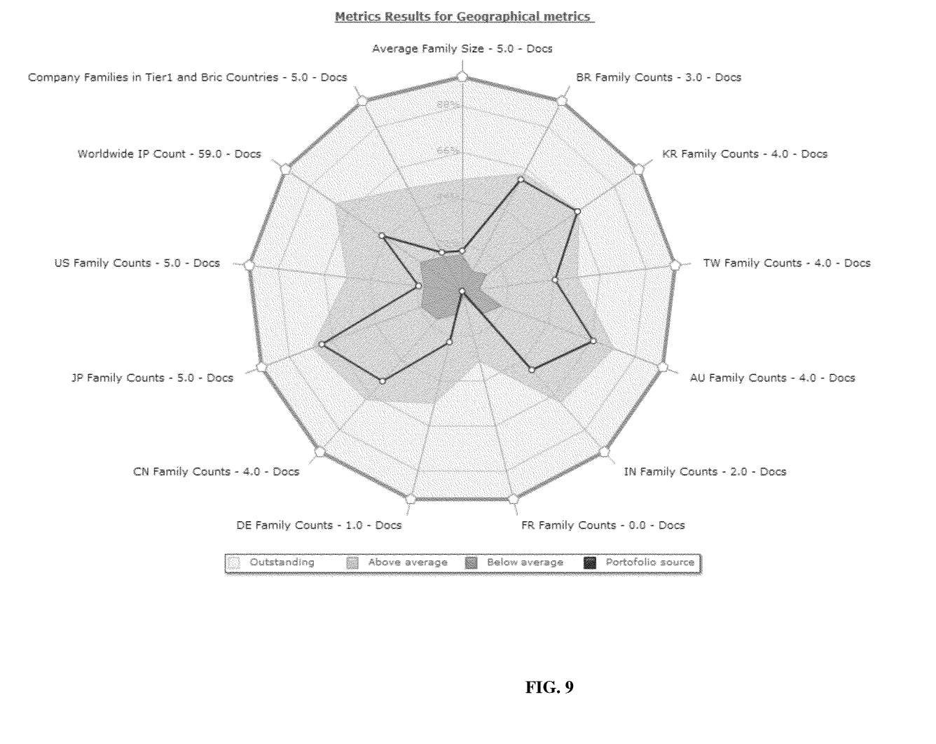

The geographies (or geographic areas such as countries or regions) in which the patents (or patent families) have been filed are illustrated in FIG. 9. In addition to a worldwide presence of the company, the company's presence (patents) in tier 1 (U.S., Germany, France, Japan for example), BRICs (Brazil, Russia, India and China), Korea, Australia and Taiwan are considered important. These countries currently represent most of the commercial activity in the world. Depending upon the technology or use of the source portfolio, the listing can be modified (i.e. geographic region can be added or subtracted). Those of skill in the art can identify countries and particular technology that is most likely to be commercially relevant for those countries. In such instances, patents corresponding to those particular technologies can be graphically displayed.

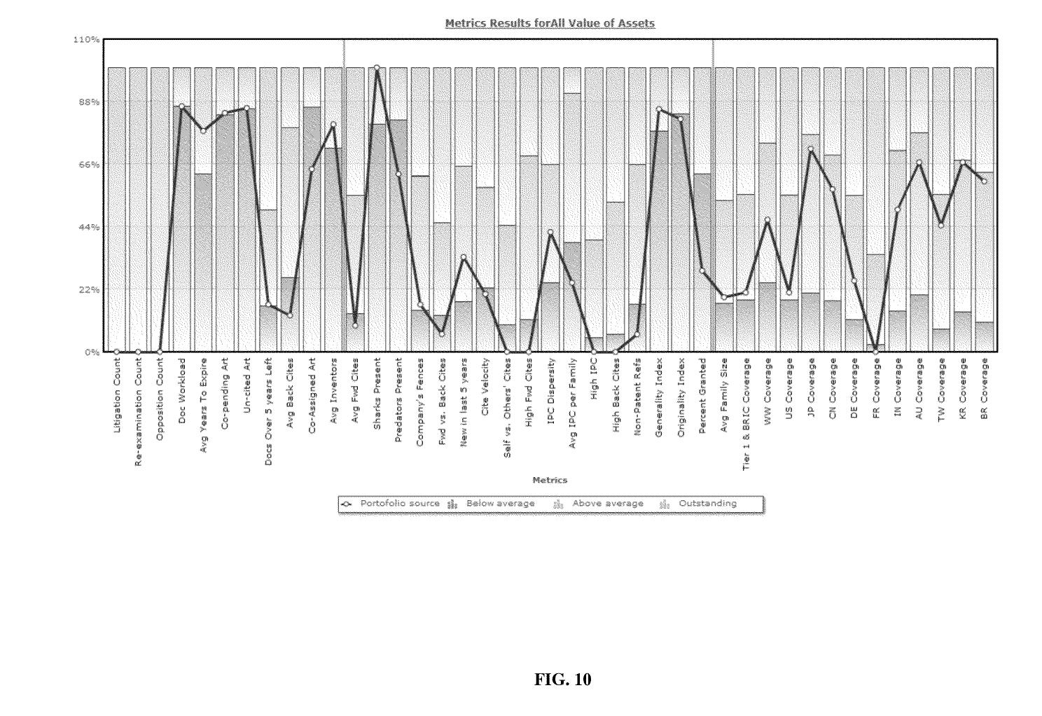

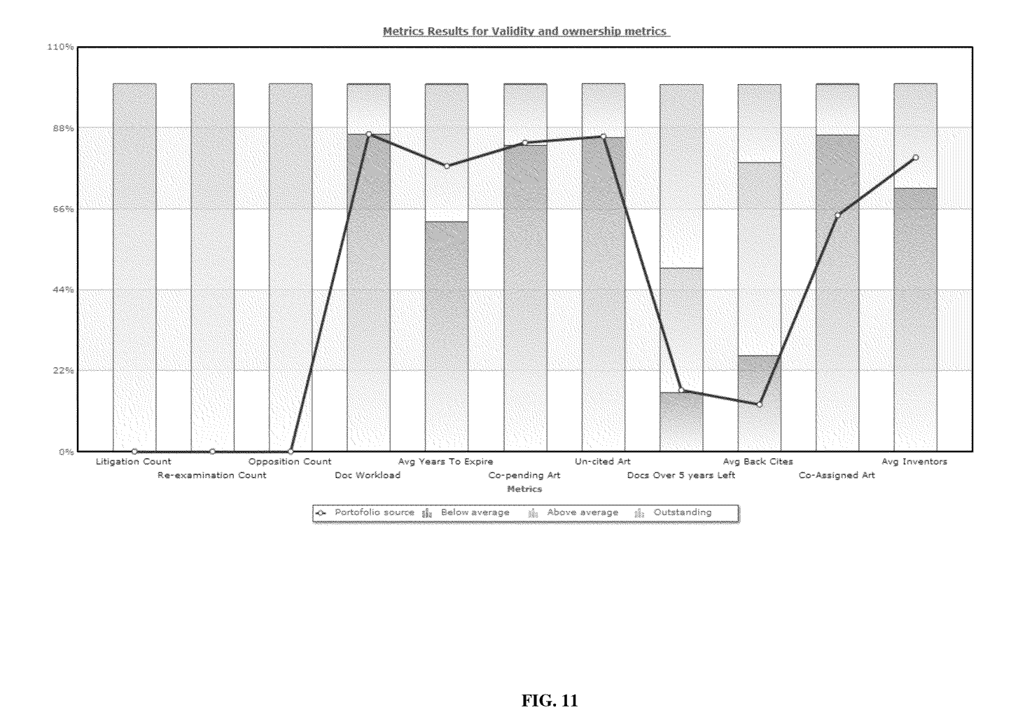

Graphical representation need not be limited to radar diagrams. Other forms such as bar graphs can also be used for displaying such information. Exemplary data may also be represented by the bar graphs of FIGS. 10 and 11. The examples provided in this specification are exemplary and not meant to limit the scope of graphic displays which could be used.

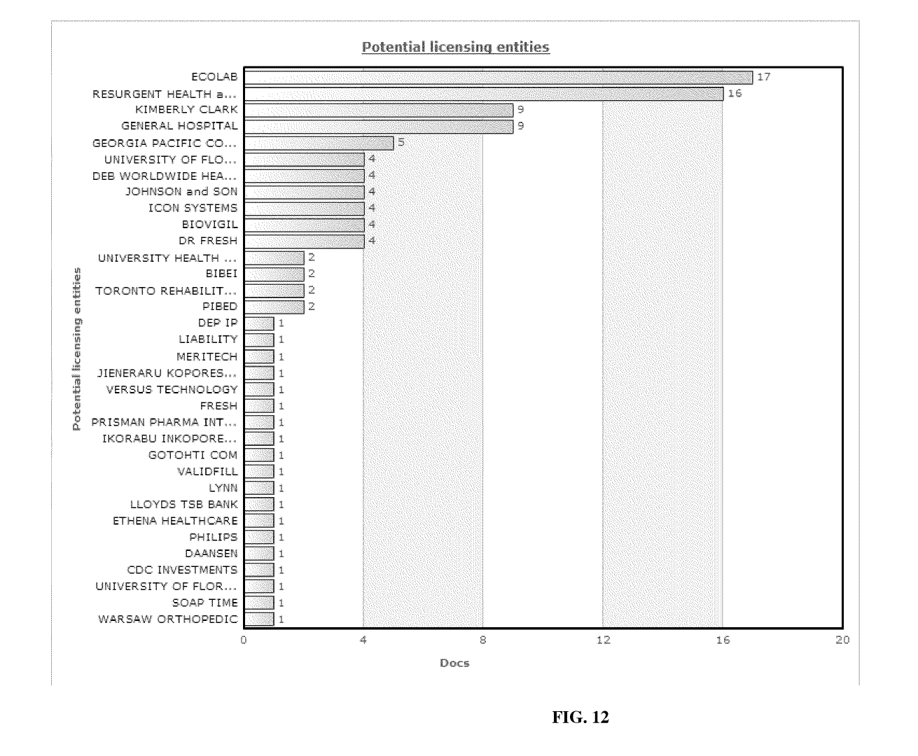

Potential licensing entities may be displayed as illustrated in FIG. 12. The companies citing the source portfolio are rank ordered by the frequency of their citations. This is a measure often used to quickly find potential licensing entities. It is not a complete or exhaustive method but exemplary of providing to the users (or source portfolio entity) with a list of potential entities to contact.

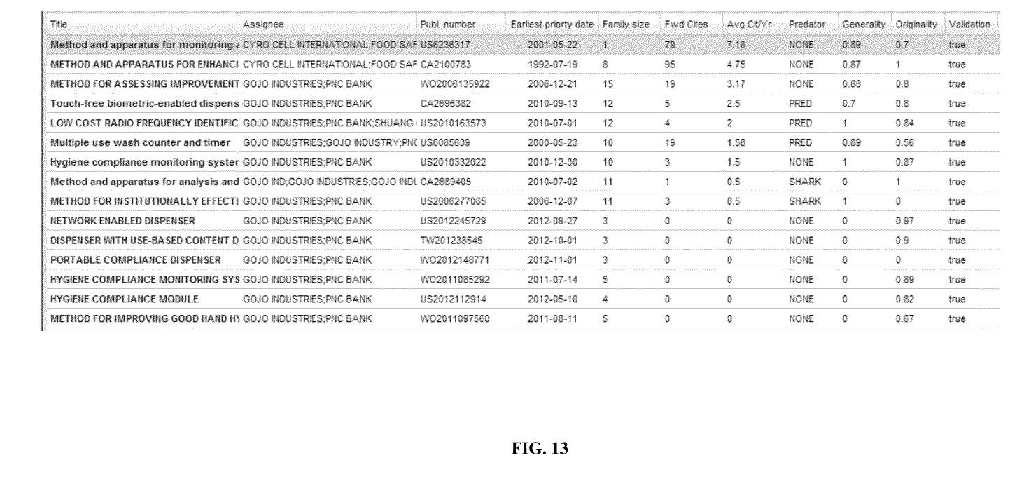

A rank order of source portfolio documents by key indicators is illustrated in FIG. 13. The key indicators may include, for example, the portfolio patent family size, the forward citations, the average citations per year, the presence of companies building fences around the source portfolio, the defined generality and originality indexes and the validation of the art by litigation, re-examination and/or opposition for example.

The rank order may be determined by the numeric value of an individual key indicator of the source portfolio documents, or a combination of the numeric values of individual key indicators. The numeric values used to establish the rank order may be from largest to smallest or vice-versa to obtain the rank order of the documents. If a combination of key indicators is used to obtain the rank order, the values of the key indicators used in the calculation may be summed, weighted, or otherwise combined to produce a rank order value.

Exemplary methods as described may be executed on a processor which can rank order the source portfolio on the basis of any of the measures that were calculated for the visual display of the graphic information. The purpose of this listing is to provide the user the list of the top patents in the portfolio that should be considered for license. This is particularly valuable where the source portfolio may consist of tens, hundreds or even thousands of patents and applications.

Various intellectual property assets are not equal in value. In the case of patent assets, for example, two patents in the same industry and relating to the same subject matter can command drastically different royalty rates in a free market. The royalty rate may depend upon a variety of factors.

Exemplary patent rating methods and systems as described herein may complement and support an overall evaluation process. An objective, statistical-based comparison method and system for substantially independently assessing the relative value or worth of a source portfolio to that of a comparison portfolio is disclosed. Novel and valuable information can be determined that can be used by patent valuation experts, investment advisors, economists and others to help guide future patent investment decisions, licensing programs, patent appraisals, tax valuations, transfer pricing, economic forecasting and planning. Mediation and/or settlement of patent litigation lawsuits can also be achieved using this information.

Such information may include, for example and without limitation: statistically calculated probabilities of particular desired or undesired qualities being present, ratings or rankings of individual patents or patent portfolios, ratings or rankings of patent portfolios held by public corporations, ratings or rankings of patent portfolios held by pre-IPO companies, ratings or rankings of named inventors and ratings or rankings of professional service firms, law firms and the like who prepare, prosecute and enforce patents or other intellectual property assets.

Exemplary embodiments provide a statistical patent comparison method and system for comparing patents based on certain selected patent characteristics or “metadata.” Such patent metadata may include a number of quantifiable parameters that directly or indirectly measure or report a quality or characteristic of a patent.

Direct patent metadata measure or report the characteristics of a patent that are revealed by the patent itself, including its basic disclosure, drawings and claims as well as the Patent and Trademark Office (PTO) record or file history relating to the patent. Specific patent metadata may include, for example and without limitation, the number of claims, number of words per claim, number of different words per claim, word density (e.g., different-words/total-words), length of patent specification, number of drawings or figures, number of cited prior art references, age of cited prior art references, number of subsequent citations received, subject matter classification and sub-classification, origin of the patent (foreign vs. domestic), payment of maintenance fees, prosecuting attorney or firm, patent examiner, examination art group, length of pendency in the PTO, claim type (i.e. method, apparatus, system), etc.

Indirect patent metadata measures or reports a quality or characteristic of a patent that, while perhaps not directly revealed by the patent itself or the PTO records relating to the patent, can be determined or derived from such information (and/or other information sources) using a variety of algorithms or statistical methods including, but not limited to, those described herein. Indirect patent metadata can include, but is not limited to, reported patent litigation results, published case opinions, patent licenses, marking of patented products and the like. Indirect patent metadata may also include derived measures or measurement components such as frequency or infrequency of certain word usage relative to the general patent population or relative to a defined sub-population of patents in the same general field.

In an exemplary embodiment, patent or patent portfolio comparisons may be generated using a database of selected patent information by identifying and comparing various relevant characteristics or metadata of individual patents contained in the database. These statistical comparisons may then be used to construct and optimize a computer model or computer algorithm comprising a series of operative rules and/or mathematical equations.

The algorithm may be used to provide statistically determined probabilities of a desired metadata value given the identified characteristics of an individual identified patent or group of patents. The algorithm may include a simple calculation of average and standard deviation which assigns scores to the relative average and multiples of standard deviation values to determine if a patent or group of patents has statistical significance. These values can be graphically displayed as described above with reference to FIG. 6.

Positive scores could generally be applied to those patent characteristics that are determined or believed to have desirable influence for example. Negative scores could be applied to those patent characteristics determined or assumed to have undesirable influence on the particular metadata element of interest.

The algorithm as developed may be executed repeatedly against one or more metadata elements of the patent populations (e.g. patents declared to be in the source portfolio or the comparison portfolio). Adjustments may be made to the algorithm for any particular company or business use the metadata elements most appropriate to setting the value or worth of the patent or patent portfolio.

Algorithm results may be reported as the normalized value using the maximum value of the metadata element and comparing it to the average of the metadata elements and outstanding business use statistical control limit (OBUSCL).

Many different methods of statistical analysis may be utilized for implementing exemplary embodiments as described herein. A standard deviation technique can be performed, for example, by a computing means such as general purpose computer. Standard deviation is a statistical technique for examining the relationship of a population of metadata.

The metadata (or independent variables) describes or quantifies certain observable characteristics of a particular patent population such as, for example, number of independent claims, length of specification, etc.

Criterion variables (or dependent variables) measure a selected quality of interest of a particular patent population, such as, for example, likelihood of successful litigation, validity or infringement, etc.

Visual display of the metadata elements allows the metadata variables to be studied as a function of their individual or combined values. These individual or combined values can, in turn, be used to predict the value or worth of the source portfolio.

Exemplary embodiments as described may be applied and implemented in various ways to achieve desired results as highlighted with particular, non-limiting, examples.

In one application, a comparative value of a company's source portfolio if it were licensed out to other entities may be determined. In this case, a company may select the patents and applications that it may consider for licensing out (i.e. the company is the licensor). The company may then use a subject matter expert or software algorithms.

By evaluating appropriate metadata elements by standard deviation methodology, a graphic display of information comparing the source portfolios value or worth to the comparative portfolio may be derived. Illustrative output for potential prosecution metadata is illustrated in FIG. 7. Illustrative output for potential technology strength and application applicable really is illustrated in FIG. 8. Illustrative output for potential geographic strength and value of the source portfolio is illustrated in FIG. 9.

In each of these cases, the source portfolios position above or below the control limit (the average value of a set of metadata elements plus (added to) twice the value of the standard deviation of s set of metadata elements, called the OBUSCL or control limit in the present disclosure) may determine if the source portfolio is outstanding in value on any one measure or if its strength lies in the pattern of results that are above average but below the OBUSCL.

The control limit or OBUSCL is an indicator of the commercial value of a patent or patent portfolio. If the patent under evaluation, or a source portfolio, has a value below average, it is not of commercial interest with respect to the metadata element under study or assessment. If the patent under evaluation, or a source portfolio, under study or assessment has a value between the average value of the metadata elements under study or assessment but less than the control limit or OBUSCL with respect to the metadata elements under study or assessment, then the patent or source portfolio under evaluation may be considered to be of commercial interest if more than five different metadata elements were in this range between the average and OBUSCL for example. If less than five metadata elements were in this range between the average and OBUSCL for example, then the portfolio may be considered to be not of commercial interest. If any one metadata element has a value over the OBUSCL then the portfolio may be considered to be of commercial interest because of this singular or multiple outstanding values (a value in excess of OBUSCL).

A formulaic representation of the OBUSCL for any one or multiple metadata elements may be represented by OBUSCL=(average)+(2*(standard deviation))

For markets and technologies that are undergoing rapid contraction or expansion, it was discovered that the OBUSCL was advantageously lowered to OBUSCL=(average)+(standard deviation), or raised to OBUSCL=(average)+(3*(standard deviation))

In another application, potential freedom to operate risks may be identified and evaluated. By evaluating appropriate metadata elements by standard deviation methodology, a graphic display of information comparing the source portfolios value or worth to the comparative portfolio may be derived. Illustrative output for potential prosecution metadata is shown in FIG. 7.

In this case, the source portfolio's position above or below the control limit determines if the source portfolio is outstanding in value on any one measure, or if its strength lies in the pattern of results that are above average but below the OBUSCL. Such information may be used identify portfolios for licensing or acquisition purposes for example.

In the case described above, the identified patent metadata are anticipated to have a statistically significant impact on the probability of a patent being litigated successfully or unsuccessfully. By undertaking a statistical study of these and other identified patent metadata and by constructing a suitable display of the source portfolio metadata compared to the average and standard deviation control limits of a comparative portfolio in accordance with exemplary embodiments disclosed herein, one can accurately calculate an estimated statistical probability of a given patent or portfolio being involved in a freedom to operate dispute.

Exemplary embodiments can be implemented as a web-based tool. It can be made available to users over a public network such as the internet or over a private network. It can be accessed as a web page. Various services, embodying different exemplary aspects, could be made available to users on a subscription or a pay-per-use basis.

As an Internet-based application, users may have access to automated patent or patent portfolio comparisons. Ancillary information can be provided and may include, for example, full-text searchable patent files, patent images, bibliographic data, ownership records, maintenance records and the like. A user may be able to enter or “click” on the number of a patent, or select a group of patents, that is of interest and obtain, in very short order (e.g., in the order of a few minutes), a comprehensive rating report as described above. The user can control most, if not all, of the variables in the comparison calculation.

A user can, for example, request that the patent be rated only against other patents in the same art group, or in a specific industry or in a particular field of use. A report can be requested on how the patent compares to all patents that have been litigated in the past 5 years, or that have been held invalid by U.S. courts. In this manner, reports could be narrowly tailored to an entity's specific interests and concerns. Different entities, e.g., lawyers, businessmen, manufacturers, investors, etc., may have slightly different appraisal needs.

It is not necessary for an entity to actually know the patent number or title of the patent in order to obtain a rating for the patent. A series of correlation tables allows an entity to retrieve patent numbers based on ownership, field of use, or even specific commercial products. Thus, for example, it is possible to request reports on all patents that have been issued or assigned to a particular company in the past 5 years.

Automatic updates and patent comparisons according to certain pre-defined parameters may be requested and obtained. For example, automatic updated reports of patents obtained by a particular company within a pre-specified time of the patents' issue may be requested. A similar updated report could be generated and sent any time a new patent issue or a new application is published in a particular technology field or class of interest. The updates can include a synopsis of each new patent or published application, as well as a patent rating performed according specified criteria.

Updated reports for each comparison patent could also be generated periodically whenever one or more identified patent metadata changes (e.g., forward citation rate, change of ownership, litigation, etc.). Such automated updating of rating information would be particularly important to investment and financial analysts who depend on rapid and reliable information to make minute-by-minute decisions. Updated report(s) could also be generated and published each week for all newly issued patents granted by the PTO for that week. Informative patent comparison information may thus be provided within days or hours of a new patent being issued and published by the PTO.

Optionally, submitters could also provide their own rating or ranking of the patent in question, such that patents could be essentially self-rated by users. In the preferred embodiment, only qualified users (or selected patent analysts) would be allowed to post such ratings. The qualification process could be as simple as filling out a questionnaire or as thorough as an independent verification of credentials. It is also possible to employ the methodology currently used by such web sites as “epinions.com” to track the popularity and veracity of individual user-submitted information and determine which users are most trusted. Those users that are most trusted would be brought to the top of the patent information database and their authors compensated according to the number of times users accessed the information, while less-popular submitters' information would sink in rank. Users and/or analysts could also be compensated financially (or otherwise) based on the accuracy of their ratings relative to the collective comparison prediction. This would motivate more careful analysis and more accurate ratings.

Exemplary embodiments as described herein can be incorporated into a newsletter service such as the numerous financial newsletters currently available to Wall Street investors. In this particular embodiment, the comparison system described herein can be applied to a pre-defined subset of issued patents such as, for example, all patents newly issued to “Fortune 500” companies or designated “Pre-IPO” companies. Overall patent comparisons would be denoted with a standardized system, such as a 1 to 10 scale, four stars, bond-style ratings, “BDR” ratings and/or the like.

Requested reports can be automatically generated and e-mailed to each subscriber on a periodic basis and/or on an event-triggered basis, as desired. In this way, subscribers can be provided with a standardized method of comparing patent portfolio comparisons of various companies from week to week or another periodic basis.

Furthermore, exemplary systems, apparatus and architecture as described above can be implemented on a processor or a computer.

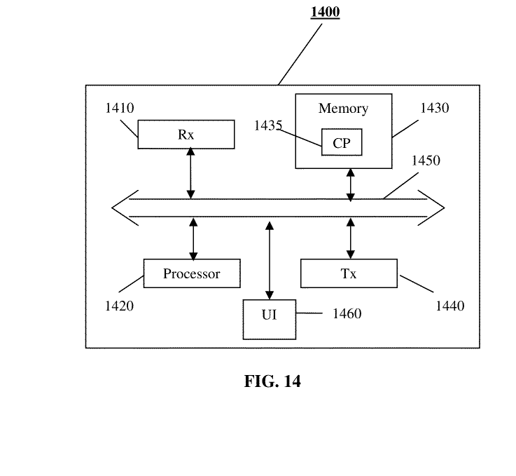

An exemplary computing device 1400 is illustrated in FIG. 14. Computing device 1400 may include, inter alia, a receiver 1410, a processor 1420, a computer readable medium 1430 in the form of a memory, a transmitter 1440 and a user interface 1460 which may be a display, a keyboard, a microphone, etc. The receiver and transmitter may be combined and referred to as a transceiver or a communication interface (e.g. a modem). Receiver 1410, processor 1420, memory 1430, transmitter 1440 and user interface 1460 may be interconnected via a bus 1450.

A program for executing an exemplary method as described with reference to FIG. 5 above may be stored in memory 1430. Search criterion for identifying a source (or comparable) portfolio may be entered via user interface 1460. In some embodiments, the search criterion may also be stored in memory 1430. The search criteria may also be included in a data file that is stored in memory 1430. The results can also be stored in memory 1430.

Processor 1420 may communicate with a database (not illustrated) via the transmitter and receiver in performing the search for identifying the source (and comparable) portfolios. The database may be located at a server (not illustrated) remote from computer 1400. The server may be accessible over a public network such as the internet. The server may also be accessible via a virtual private network. The connection between the computer and the server may be a secure connection utilizing encryption for example. The similarity algorithm may be stored in memory 1430 or retrieved or invoked from a remote location.

The results of the search for the portfolios as well as the computed metrics presented in a graphical form may be presented on the user interface (e.g. a display). The computed metrics in the graphical form may also be output to a output device such as a printer (not illustrated). The computed metrics may also be stored in memory 1430.

In one embodiment, in order for processor 1420 to perform the steps illustrated in FIG. 5, memory 1430 may comprise a computer program (CP) 1435 with computer program modules which when run by the processor 1420 causes the computing device 1400 to perform all or some of the steps illustrated in FIG. 5.

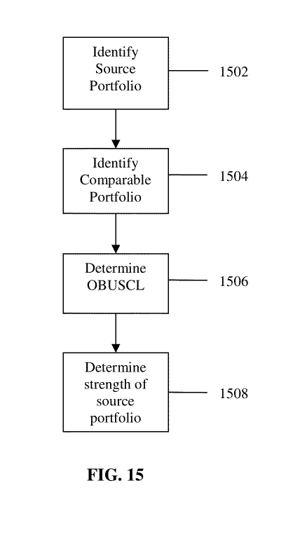

A further exemplary embodiment may be described with reference to FIG. 15. A source portfolio may be identified at 1502. A comparable portfolio may be identified at 1504. Metrics such as the outstanding business use statistical control limit (OBUSCL) may be determined at 1506. The OBUSCL may be utilized to determine the strength of the source portfolio at 1508.

The information obtained for the source and comparable portfolios may be analyzed to provide the metrics and represent the metrics via the exemplary graphical formats described above. In this manner, the data is transformed via the computing machine and displayed or presented in a manner that facilitates business decision making.

While various application embodiments of the present disclosure have been described above, it should be understood that they have been presented by way of example only, and not limitation. Thus, the breadth and scope of the present disclosure should not be limited by any of the above-described exemplary embodiments.

The present disclosure is not limited to performing a search on U.S. patents (this is also true for all of the searches discussed herein). The search performed is typically, but is not limited to, a Boolean and/or natural language search on the product, use and/or technology to produce a group of patents that identify products, uses and/or technologies covered in the company's patent portfolio. The present disclosure is not limited to exemplary methods.

Exemplary embodiments have been described with reference to particular embodiments. The present disclosure refers to patents, intellectual property, intellectual property assets, and intellectual assets, and such terms are used interchangeably herein.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In the following claims, the terms used should not be construed to limit the claims to the specific embodiments disclosed in the specification and the claims, but should be construed to include all possible embodiments along with the full scope of equivalents to which such claims are entitled. The claims are not limited by the disclosure.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

TABLE I
Validity and Ownership Value of Assets

| | Value Correlation & Literature | |
|---|---|---|
| Metrics Label | Summary of Metric's Use | Metric Definition |
| Litigation | Positive - Patents that survive | Number of patent families in an assignee's |
| Frequency | litgation are enforceable | portfolio reported in US litigation database |
| Reexamination | Positive - Patents that survive | Number of patent families in an assignee's |
| Frequency | reexamination are likely | portfolio having at least one family member |
| | enforceable | involved in re-examination |
| Opposition | Positive - Patents that survive | Number of patent families in an assignee's |
| Frequency | opposition are likely enforceable | portfolio having at least one family member |
| | | that survived an opposition process |
| Worldwide | Negative - Large numbers of | Total Patent and Application Count (all |
| Document | patents increases legal workload | families and all family members) in an |
| Workload | and filing errors | assignee's portfolio that are in force |
| Lifetime of In Force | Positive - Longer life means art | Overall average years left comprised of all |
| IP | has been referenced/refuted by | individual patent family members in |
| | others | assignee's portfolio |
| Potential Copending | Negative - If there was copending | Number of patent families in an assignee's |
| prior art conflicts | art the examiner may not have | portfolio that have an individual patent |
| | seen it and cited it as a reference | family member where at least one of the top |
| | | 90% significant documents (via similarity |
| | | search) is co-pending (applications with a |
| | | date after source filing date but before source |
| | | publication) and is not a backward citation |
| Potential uncited | Negative - If there was uncited | Number of patent families in an assignee's |
| prior art conflicts | prior art the patent will be weak in | portfolio that have an individual patent |
| | litigation | family member where at least one of the top |
| | | 90% significant documents (via similarity |
| | | search) has an earlier filing date than the |
| | | source patent filing (application) date and is |
| | | not a backward citation |
| Optimum Age for | Positive - Art needs to have | Number of patent families in assignee's |
| Licensing | enough life left to be worth | portfolio having at least one family member |
| | licensing | with over five years of life left |
| Reference Diligence | Positive - More references made of | Overall average of backward citations taken |
| | record helps validity | from all individual patent family members in |
| | | assignee's portfolio |
| Co-Assigned Art | Negative - Co-assigned art has | Number of patent families in an assignee's |
| | enforcement problems if parties | portfolio that have more than one assignee |
| | are un-cooperative | |
| Average number of | Negative - Many inventors during | Overall average number of inventors taken |
| Inventors | litigation may undermine the case | from all individual patent family members in |
| | with many stories | an assignee's portfolio |

TABLE II
Technical and Use Value of Assets

| | Value Correlation & Literature | |
|---|---|---|
| Metrics Label | Summary of Metric's Use | Metric Definition |
| Average number of | Positive - Other's following patent | Overall average of forward citations taken |
| forward citations | demonstrates Company Technical/ | from all individual patent family members in |
| | IP Leadership | an assignee's portfolio |
| Sharks Present in | Negative - Presence of an IP Shark | Total number of patents/applications in an |
| Citation Patent | indicates technology was of | assignee's portfolio wherein over 30% of the |
| Fences | commercial value | forward citations of the individual patents or |
| | | applications are from a single entity that is |
| | | not the same assignee |
| Predators Present in | Negative - Presence of an IP | Total number of patents/applications in an |
| Citation Patent | Predator indicates technology was | assignee's portfolio wherein over 15% and |
| Fences | of commercial value | less that 30% of the forward citations of the |
| | | individual patents or applications are from a |
| | | single entity that is not the same assignee |
| Company's self- | Positive - Presence of an patent | Total number of patents/applications in an |
| patent Fences | fence indicates assignee felt | assignee's portfolio wherein over 30% of the |
| | technology was of commercial | forward citations of the individual patents or |
| | value | applications are from the same assignee |
| | | (self-citations) |
| Average Forward to | Positive - If more people cite than | Overall average of forward citations divided |
| Backward Citation | were prior art, then patent is likely | by backward citations taken from all |
| Ratio | a next-generation improvement | individual patent family members in an |
| | | assignee's portfolio |
| New Families in last | Positive - If patent is filed in many | Number of patent families in an assignee's |
| 5 years | countries, assignee thinks it has | portfolio that have at least one family |
| | commercial value | member that was filed in the last five years |
| Citation Velocity | Positive - If lots of citation activity | Overall average of number of forward |
| | then others think art has | citations per year since publication taken |
| | commercial value | from all individual patent family members in |
| | | an assignee's portfolio |
| Average Self to | Positive - Assigee can best assign | Overall average of forward self-citations |
| Others' Citation | value and the need to protect | divided by total citations taken from all |
| Ratio | derivative innovation | individual patent family members in an |
| | | assignee's portfolio |
| Families with | Positive - Grandfather patents have | Number of patents/applications in an |
| Statistically High | statistically Outstanding citation | assignee's portfolio wherein the number of |
| Citation Counts | counts | forward citations is in excess of the average |
| | | plus two standard deviations derived from |
| | | the number of forward citations of individual |
| | | patents in the set of source/comparable |
| | | documents |
| IPC Dispersity in | Positive - More technology and | Total number of different IPC/CPC subclass |
| Company's Portfolio | uses represents more licensing | (i.e. H04G) in all individual patent family |
| | opportunities | members in an assignee's portfolio |
| Average IPC Count | Positive - More technology and | Average number of IPC/CPC subclass (i.e. |
| of Family | uses represents more licensing | H04G) in each individual patent family |
| | opportunities | member in an assignee's portfolio |
| Families with | Positive - Broad patents covering | Number of patents/applications in an |
| statistically high | non-contingous technologies or | assignee's portfolio wherein the number of |
| IPC counts | uses have statistically outstanding | IPC/CPC subclass is in excess of the average |
| | IPC counts | plus two standard deviations derived from |
| | | the number of IPC/CPC subclass of |
| | | individual patents in the set of |
| | | source/comparable documents |
| Families with | Positive - Grandfather Systems | Number of patents/applications in assignee's |
| Statistically High | patents have statistically | portfolio wherein the number of backward |
| Reference Counts | Outstanding reference counts | citations (references) is in excess of the |
| | | average plus two standard deviations derived |
| | | from the number of backward citations of |
| | | individual patents in the set of |
| | | source/comparable documents |
| Originality | Positive - Non-patent references | Overall average of number of non-patent |
| Scientific Novelty | correlate to scientific novelty | references divided by number of backward |
| | | patent citations taken from individual patent |
| | | family members in assignee's portfolio |
| Generality Index - | Positive - Generality Index as | Average in an assignee's portfolio comprised |
| Dispersity of IPC in | defined by Hall, Jaffe, and | of, for each individual granted patent with |
| Citations | Trajtenberg (2001) indicates a | two or more forward citations, (the number |
| | broad patent | of forward citations to a patent divided by |
| | | the number of forward citations to a patent |
| | | minus one) times (one minus the sum of the |
| | | squares of (the number of forward citations |
| | | to a patent that contain each IPC/CPC |
| | | subclass present in all forward citations of |
| | | the patent divided by the number of forward |
| | | citations to the patent)) |
| Originality Index - | Positive - Originality Index as | Average for an assignee's portfolio |
| Dispersity of IPC in | defined by Hall, Jaffe, and | comprised of (for each individual granted |
| References | Trajtenberg (2001) indicates a | patent with two or more forward citations, |
| | grandfather patent | the (number of forward citations to a patent |
| | | divided by the number of forward citations |
| | | to a patent minus one) times (one minus the |
| | | sum of the squares of (the number of forward |
| | | citations to a patent that contain each |
| | | IPC/CPC subclass present in all forward |
| | | citations of the patent divided by the number |
| | | of forward citations to the patent))) |
| % Patents from | Positive - Examiner agrees | Ratio of patent applications to granted |
| Applications Ratio | technology/use is original | patents in an assignee's portfolio |

TABLE III
Geographic Value of Assets

| | Value Correlation & Literature | |
|---|---|---|
| Metrics Label | Summary of Metric's Use | Metric Definition |
| Average Family | Positive - More patent families | Average number of patent family members |
| Size | indicates assignee has worldwide | in each patent family in an assignee's |
| | commercialization/licensing | portfolio |
| | plans | |
| Company Families | Positive - More patent families | The total number of patents/applications in |
| in Tier1 and BRIC | means more licensing | an assignee's portfolio (documents not patent |
| Countries | opportunities in the world's major | families) in the below countries |
| | markets | |
| Worldwide IP | Positive - More patent families | The total number of patents/applications in |
| Count | means more licensing | an assignee's portfolio (documents not patent |
| | opportunities in the world | families) |
| US Family Counts | Positive - More patent families | The total number of patents/applications in |
| | means more licensing | an assignee's portfolio (documents not patent |
| | opportunities in this country | families) in this country |
| JP Family Counts | Positive - More patent families | The total number of patents/applications in |
| | means more licensing | an assignee's portfolio (documents not patent |
| | opportunities in this country | families) in this country |
| CN Family Counts | Positive - More patent families | The total number of patents/applications in |
| | means more licensing | an assignee's portfolio (documents not patent |
| | opportunities in this country | families) in this country |
| DE Family Counts | Positive - More patent families | The total number of patents/applications in |
| | means more licensing | an assignee's portfolio (documents not patent |
| | opportunities in this country | families) in this country |
| FR Family Counts | Positive - More patent families | The total number of patents/applications in |
| | means more licensing | an assignee's portfolio (documents not patent |
| | opportunities in this country | families) in this country |
| IN Family Counts | Positive - More patent families | The total number of patents/applications in |
| | means more licensing | an assignee's portfolio (documents not patent |
| | opportunities in this country | families) in this country |
| AU Family Counts | Positive - More patent families | The total number of patents/applications in |
| | means more licensing | an assignee's portfolio (documents not patent |
| | opportunities in this country | families) in this country |
| TW Family Counts | Positive - More patent families | The total number of patents/applications in |
| | means more licensing | an assignee's portfolio (documents not patent |
| | opportunities in this country | families) in this country |
| KR Family Counts | Positive - More patent families | The total number of patents/applications in |
| | means more licensing | an assignee's portfolio (documents not patent |
| | opportunities in this country | families) in this country |
| BR Family Counts | Positive - More patent families | The total number of patents/applications in |
| | means more licensing | an assignee's portfolio (documents not patent |
| | opportunities in this country | families) in this country |

TABLE IV

| Assignee | Doc Count | # Shark Docs | % | Normalized |
|---|---|---|---|---|
| Source | 5 | 1 | 0.2 | 0.4 |
| 1 | 50 | 0 | 0 | 0 |
| 2 | 25 | 0 | 0 | 0 |
| 3 | 15 | 0 | 0 | 0 |
| 4 | 11 | 3 | 0.272727 | 0.545454545 |
| 5 | 8 | 0 | 0 | 0 |
| 6 | 4 | 2 | 0.5 | 1 |
| 7 | 4 | 1 | 0.25 | 0.5 |
| 8 | 4 | 1 | 0.25 | 0.5 |
| 9 | 4 | 1 | 0.25 | 0.5 |
| 10 | 4 | 0 | 0 | 0 |
| 11 | 4 | 0 | 0 | 0 |
| 12 | 4 | 0 | 0 | 0 |
| 13 | 4 | 0 | 0 | 0 |
| 14 | 4 | 0 | 0 | 0 |
| 15 | 4 | 0 | 0 | 0 |
| 16 | 1 | 0 | 0 | 0 |
| 17 | 1 | 0 | 0 | 0 |
| 18 | 1 | 0 | 0 | 0 |
| 19 | 1 | 0 | 0 | 0 |
| 20 | 1 | 0 | 0 | 0 |
| 21 | 1 | 0 | 0 | 0 |
| 22 | 1 | 0 | 0 | 0 |
| 23 | 1 | 0 | 0 | 0 |
| 24 | 1 | 0 | 0 | 0 |
| 25 | 1 | 0 | 0 | 0 |
| | | average | 0.066259 | 0.132517483 |
| | | Stdev | 0.132323 | 0.264646005 |
| | | Control | 0.330905 | 0.661809492 |
| | | max | 0.5 | 1 |
| | | min | 0 | 0 |

What is claimed is:

1. A computer implemented method for evaluating intellectual property assets, the method comprising the steps of:
identifying a source portfolio of intellectual property assets;
identifying a comparable portfolio of intellectual property assets;
computing metrics for a plurality of parameters associated with the intellectual property assets;
comparing the computed metrics of the source portfolio with computed metrics of the comparable portfolio parameters of all portfolios; and
determining a strength of the source portfolio based on the comparison, wherein the compared parameters are divided into a plurality of categories, said categories including at least validity and ownership value of the assets, technical and use value of the assets and geographic value of the assets.

2. The method of claim 1, wherein the intellectual property assets comprise granted patents and pending patent applications.

3. The method of claim 2, wherein the computing of the plurality of metrics comprises:
grouping the comparable portfolio assets by assignee;
determining an average value of each parameter for all of the intellectual assets;
determining an average value of each parameter for each of the assignees and for the source portfolio; and
comparing the average value of a parameter of the source portfolio with the average value of the parameter for all intellectual assets.

4. The method of claim 3, wherein a plurality of parameters are positive parameters or negative parameters.

5. The method of claim 4, wherein the strength of the source portfolio:
increases if a source portfolio parameter value is greater than the corresponding comparable source value parameter for positive parameters; and
decreases if the source portfolio parameter value is greater than the corresponding comparable source value parameter for negative parameters.

6. The method of claim 4, wherein the strength of the source portfolio:
increases if a source portfolio parameter value is less than the corresponding comparable source value parameter for negative parameters; and
decreases if a source portfolio parameter value is greater than the corresponding comparable source value parameter for negative parameters.

7. The method of claim 3, further comprising:
plotting on a radar diagram the average values for all intellectual assets, the average values for intellectual assets of each assignee and the average values for the intellectual assets of the source portfolio, wherein the average values for each parameter are plotted along one axis of the radar diagram.

8. The method of claim 3, further comprising:
plotting on a bar chart the average value for all intellectual assets, the average value for intellectual assets of each assignee and the average value for the intellectual assets of the source portfolio.

9. The method of claim 1, wherein the source portfolio is identified by a search based on user defined criterion.

10. The method of claim 9, wherein the comparable portfolio is identified based on the source portfolio and on a similarity algorithm.

11. The method of claim 10, wherein the assets for the comparable portfolio are selected based on a degree of their relevance to assets in the source portfolio based on a pre-specified relevance.

12. The method of claim 1, wherein the plurality of parameters that are compared are obtained from metadata associated with granted patents and published patent applications, the metadata indicating a quality or characteristic of the patent document.

13. A computer implemented method for evaluating intellectual property assets, the method comprising the steps of:
identifying a source portfolio of intellectual property assets;
identifying a comparable portfolio of intellectual property assets;
determining an outstanding business use statistical control limit (OBUSCL) for a plurality of parameters associated with the intellectual property assets; and
determining a strength of the source portfolio based on the OBUSCL.

14. The method of claim 13, wherein the determining of the OBUSCL further comprises:
grouping the comparable portfolio intellectual assets by assignee;
determining an average value for each of a plurality of parameters associated with the all intellectual assets including those of the source and of the comparable portfolios;
determining an average value of each parameter for intellectual assets of the source portfolio and for each of the assignees in the comparable portfolio;
comparing the average value of a parameter of the source portfolio with the average value of the parameter for all intellectual assets; and
identifying parameters of the source portfolio assets having an average value exceeding the average value of all intellectual assets.

15. The method of claim 14, wherein the OBUSCL is the average value for a parameter of the source portfolio assets that is two standard deviations above the average value for the parameter for all assets.

16. The method of claim 15, wherein a position of a source portfolio above the OBUSCL is deemed more desirable and a position below the OBUSCL is deemed less desirable.

17. The method of claim 13, wherein the parameters in the validity and ownership value category include at least one of: litigation frequency, re-examination frequency, opposition frequency, worldwide document workload, patent age, potential copending prior art conflicts, potential uncited prior art conflicts, reference submission diligence, co-assigned art and number of inventors.

18. The method of claim 13, wherein the parameters in the technical and use value category include at least one of: average number of forward citations, presence of predatory entities in patent fences, an assignee's patent fences, an average ratio of forward and backward citations, new patent families over a pre-specified past time period, citation velocity, average citation ratio of self to others, families with statistically high citation counts, international patent classification (IPC) diversity, average IPC count in a patent family, patent families with statistically high IPC count, number of non-patent references and patent allowance rate.

19. The method of claim 13, wherein the parameters in the geographic value category include at least one of: average family size, number of patent families in tier 1 or BRIC countries, worldwide intellectual property (IP) count and the number of patent families in a plurality of specified countries.

20. A computing device comprising:
a user interface for receiving user input and for displaying data to the user;
a transceiver for enabling the computing device to communicate with a server located remote from the computing device;
a memory for storing user input and data obtained from the server; and
a processor configured to:
identify a source portfolio of intellectual property assets based on the user input;
identify a comparable portfolio of intellectual property assets;
determine an outstanding business use statistical control limit (OBUSCL) for a plurality of parameters associated with the intellectual property assets; and
determine a strength of the source portfolio based on the OBUSCL.
